(19) United States
(12) Patent Application Publication
(10) Pub. No.: US 2006/0209174 A1
(43) Pub. Date: Sep. 21, 2006

(54) System and method for selective media recording and playback

(76) Inventors: Emad S. Isaac, Woodridge, IL (US); Robert F. D'Avello, Lake Zurich, IL (US)

Correspondence Address: DONNA & WILLIAM CONN, 20306 SEABROOK DRIVE, MONTGOMERY VILLAGE, MD, 20886, US

(21) Appl. No.: 11/082,312

(22) Filed: Mar. 17, 2005

(51) Int. Cl. H04N 7/14

(52) U.S. Cl. 348/14.01

(57) ABSTRACT

A system and method for managing content between different client devices in various domains (such as vehicle, home, and person). The system and method includes a content playback control device that is capable of managing content for a client device. The content playback control device may include an input, a memory, a controller, and an output. The input may be used for receiving an instruction from a user to subsequently playback content on the client device. The instruction includes a selection of a first format and a second format for a particular event or program. The memory may be used for storing the content in the first format and the second format. The controller is used for synchronizing the content in the first format with the content in the second format to produce a stream of the content in a combined format. The output may then be used for transmitting the combined format to the client device.

### FIELD OF THE INVENTION

This invention in general relates to managing content between devices in various domains and, more particularly, to a system and method for selective media recording and playback of content.

### BACKGROUND OF THE INVENTION

Digital video recorders exist that allow a user to pause and store video content and playback the video content at a later time. Conventional systems, however, are limited in that they only deal with storing video content and playing back the content in a single domain.

A need exists for a user to seamlessly listen to (or watch) audio (or video) content when moving from one device (such as a component in a vehicle entertainment system) to a different device (such as a component in a home entertainment system). For instance, assume that a user is driving in their vehicle and listening to an audio broadcast content on their radio such as a talk show or a sporting event. When the user arrives at their home and parks the vehicle, the user may wish to playback the broadcast content at a later time and, preferably, with a different device (such a component in their home entertainment system). One of the problems with existing systems is that different devices have different media capabilities such as varying audio formats, video formats, memory limits, screen limits, volume settings, and network capabilities. This makes the handoff of content from one device to another device difficult.

Moreover, there is a need for recording different forms of content that cover the same event or program. For instance, a sporting event may be covered by both radio and television. A need exists for selective recording of such various forms of content and enabling the playback on various client devices across multiple domains.

It is, therefore, desirable to provide a system and method to overcome or minimize most, if not all, of the preceding problems especially in the area of selective media recording and playback.

### BRIEF DESCRIPTION OF THE DRAWINGS

FIG. 1 is a block diagram of a communication system having client devices in different domains supported by a media playback control device;

FIG. 2 is a block diagram of one embodiment of a client device in the vehicular domain;

FIG. 3 is a perspective view of the inside of a vehicle illustrating one embodiment of a client device in the vehicular domain;

FIGS. 4-5 is a diagram of one embodiment of a user input mechanism for the user to enable the playback of content on a second device;

FIG. 6 is a block diagram of one embodiment of a media playback control device that communicates with different client devices in different domains;

FIG. 7 is a diagram of one embodiment of a database that may reside in a media playback control device to access information and characteristics about a particular client device;

FIG. 8 is a block diagram of a media playback control device having access to various audio and video content; and

FIG. 9 is a flow diagram of one method for managing content between a first client device and a second client device.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a system and method for selective media recording and playback of content on a client device. To this end, in one embodiment there is a method for managing content for presentation on a client device. The method comprises the steps of: receiving an input from a user to present content on the client device; providing a plurality of format options to the user, the user capable of selecting a first format and a second format for the content; accessing the content in a first format; accessing the content in a second format; combining the content in the first format with the content in the second format to provide the content in a combined format; and presenting the combined format on the client device.

The content may be a variety of types including different broadcast content and stored content. Broadcast content may include digital content such as from a digital satellite communication system. Broadcast content may also include analog or digital content from local radio broadcasters over a radio tuner. The content may also be stored content in that a user may have the system store and manage personal content and content that is accessible from content providers.

In any event, the above method may also be used between multiple client devices across various domains. For instance, the step of receiving an input from a user to present content may be done in a first client device in first domain and the step of presenting the combined format is done on a second device in a second domain. The first domain and the second domain may include areas such as the vehicle, home, person, work, or commercial hotspot.

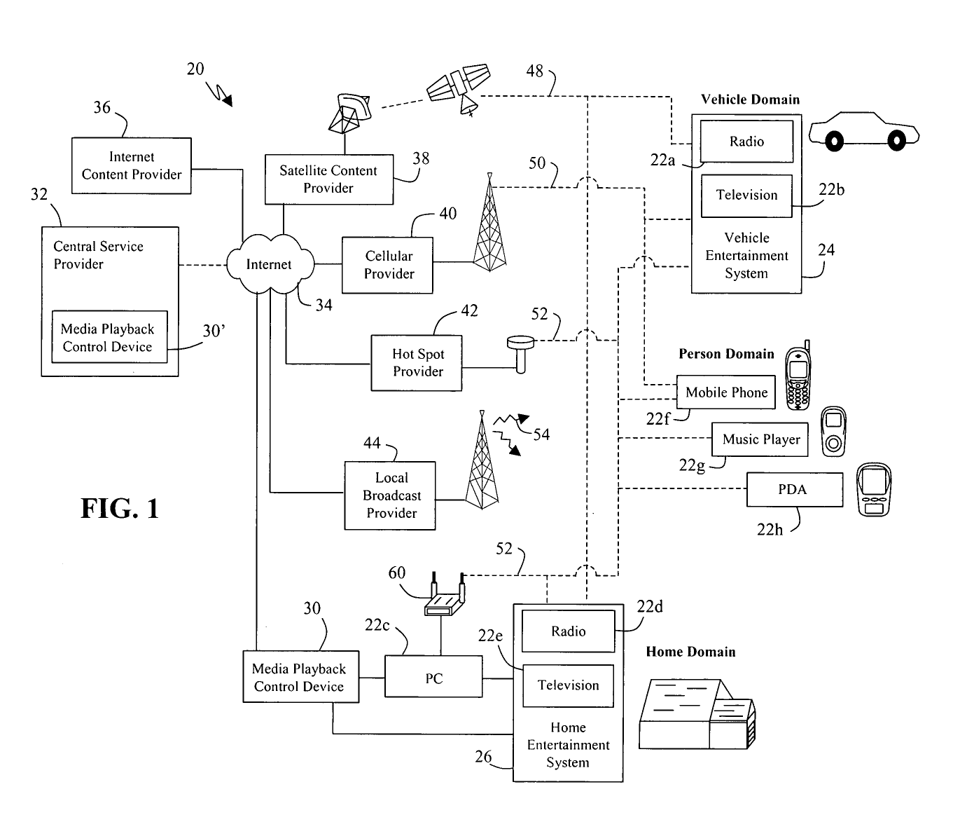

Now, turning to the drawings, FIG. 1 illustrates a top-level block diagram of an example use of a communication system 20 for the present invention. Generally, the communication system 20 may include a plurality of client devices 22a-22h that exist in various domains such as the vehicle, the home, and on the person. For instance, a client device in the vehicular domain may include a vehicle entertainment system 24 that includes components such as a radio 22a and a television 22b. A client device in the home domain may include a personal computer 22c or a home entertainment system 26 that includes components such as a home radio 22d and a home television 22e. A client device in the personal domain may include a portable electronic device such as a mobile phone 22f, a digital music player 22g, a personal digital assistant (PDA) 22h, or other portable media ready device. Client devices may also exist in other domains such as a hotspot, workplace, or school.

At the heart of the communication system 20 is a media playback control device 30 that can communicate with the client devices 22a-22h through a combination of wired links and wireless links. The media playback control device 30 assists in managing the distribution and control of content between the different client devices 22a-22h and across different domains. In one embodiment, some or all of the functions of media playback control device 30 may reside locally with a user in the home domain. In another embodiment, some or all of the functions of a media playback control device 30′ may reside with a central service provider 32. Here, the central service provider 32 is connected to a high-speed Internet network 34. The central service provider 32 may further provide additional services or be incorporated into the services of other service providers such as an Internet content provider 36, a satellite content provider 38, a cellular provider 40, a hot spot provider 42, or other content providers such as a cable television provider.

In one embodiment, where the client device 22a-22h has a content transceiver, the client devices 22a-22h may receive content (audio and/or video) over one or more wired or wireless links from one or more of the service and content providers. For instance, in one embodiment, a radio 22a of a vehicle entertainment system 24 or a radio 22d of a home entertainment system 26 may be configured to receive audio related content from a satellite radio provider 38 (through a satellite link 48), a local radio broadcast provider 44 (through a local broadcast link 54), and/or an Internet radio provider 36 (through a cellular link 50 or a wireless local area network link 52). Depending on the configuration and design of the vehicle entertainment system 24 or home entertainment system 28, the radios 22a, 22d may be capable of playing live radio-audio, recorded radio-audio, live television-audio, recorded television-audio, or other stored audio content.

The television 22b of a vehicle entertainment system 24 or the television 22e of a home entertainment system 26 may be configured to receive video related content from a satellite video provider 38, a local video broadcast provider 44, and/or an Internet content provider 36 through similar wireless links 48, 50, 52, 54. Depending on the configuration and design of the vehicle entertainment system 24 or home entertainment system 26, the television 22b, 22e may be capable of playing live television-video, recorded television-video, or other stored video content.

Likewise, client devices 22f-22h in the personal domain may be configured to receive audio or video content from one or more video or audio content providers 36, 38, 40, 42, 44 through wireless links 48, 50, 52, 54. Depending on the configuration and design of the client devices 22f-22h, the client devices 22f-22h may be capable of playing live radio-audio, recorded radio-audio, live television-audio, recorded television-audio, live television-video, recorded television-video, and/or other stored audio or video content.

As mentioned above, the client devices 22a-22h may wirelessly communicate in the communication system 20 through different communication links 48, 50, 52, 54. The wireless communication links 48, 50, 52, 54 may conform to different types of wireless communication protocols. For instance, the client devices 22a, 22b, 22d, 22e may include a wireless transceiver that is capable of establishing a wireless communication link 48 through a satellite communication system. The wireless communication link 48 with the satellite communication system can provide for the receipt of video and audio content as well as the transmission and reception of data messages.

Additionally, one or more client devices 22a, 22b, 22f-22h may include a wireless transceiver that is capable of establishing a wireless communication link 50 through a cellular communication system and network. The cellular communication system and network may operate according to a wireless communication protocol such as a Global System for Mobile Communications (GSM) protocol, a Universal Mobile Telephony System (UMTS) protocol, a Code Division Multiple Access (CDMA) protocol, a Wideband CDMA (WCDMA) protocol, a CDMA2000 protocol, or a Time Division Multiple Access (TDMA) protocol. Here, the cellular system or network is further coupled to the Internet 34 by the cellular service provider 40 or other wired network on route to the media playback control device 30, which may ultimately act as the host for data message communications between client devices 22a-22h.

Additionally, the client devices 22a-22h may include a wireless transceiver that is capable of establishing a wireless communication link 52 through a short-range wireless communication system or network. In this embodiment, the short-range wireless communication system or network may include a Bluetooth™ communication system, an IEEE 802.11 communication system, an IEEE 802.20 communication system, a wireless universal serial bus (WUSB) system, or a dedicated short-range communications (DSRC) system. The short-range wireless transceiver in a client device 22a-22h may provide direct communication to another client device 22a-22h through a home wireless gateway 60 (such as from the client device 22a, 22b in the vehicle to the client device 22d, 22e in the home). Alternatively, the short-range wireless transceiver in a client device 22a-22h may provide indirect wireless communication to another client device through a hot spot provider 42 (such as from a client device 22a, 22b in the vehicle, through the hot spot provider 42, to the client device 22d, 22e in the home). The wireless communication links over the short-range communication system can provide for the exchange of data messages as well as the transfer of stored content to client devices. The above described wireless communication protocols are merely representative of existing protocols that could be used in the present invention.

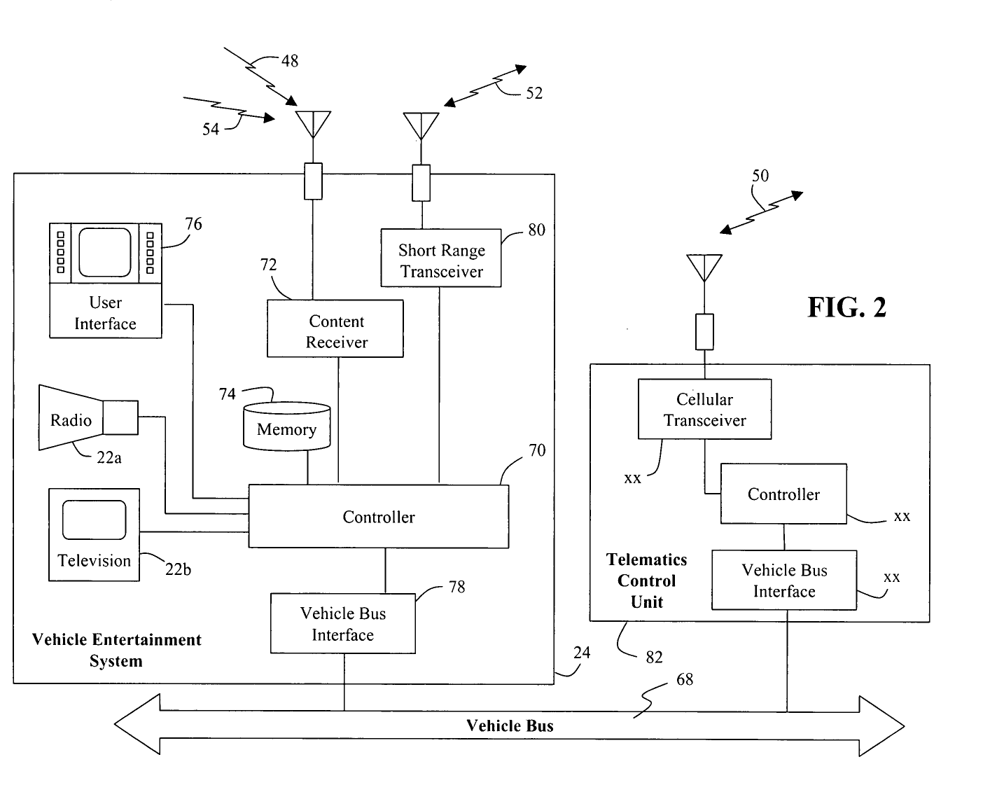

An exemplary client device in a vehicular domain will now be described in further detail with relation to FIGS. 2-5. In one embodiment, a client device 22a, 22b may be incorporated into a vehicle entertainment system 24. The vehicle entertainment system 24 may be connected to a Telematics control unit 82 through a vehicle bus 68. Although shown as separate components for purposes of illustration, one skilled in the art having the benefit of this disclosure will recognize that aspects of the vehicle entertainment system 24 and the Telematics control unit 82, and components thereof, can be combined or swapped. In any event, in the embodiment as shown in FIG. 2, the vehicle entertainment system 24 may include a controller 70, a content receiver 72, a memory 74, a user interface 76, and a vehicle bus interface 78. Depending on the configuration of the vehicle entertainment system 24, vehicle entertainment system 24 may also include a short-range wireless transceiver 80 to receive content and data messages over the communication link 52.

The user interface 76 may include a keypad or a specific user dedicated set of buttons. The user may use the keypad or dedicated buttons to perform particular functions of the present invention, including a request to present the content for playback on a different client device. Additionally, a microphone (not shown) may also be used to pick up a speaker's voice in the vehicle, and/or possibly to give commands to vehicle entertainment system 24 if it is equipped with a voice recognition module. Ultimately, user inputs are processed by the controller in vehicle entertainment system 24. The controller 70 also executes processes to provide outputs to the occupants in the vehicle through the user interface 76.

The content receiver 78 associated with the client devices 22a, 22b are capable of receiving broadcast content (audio and/or video) from a content provider. In one embodiment, the content receiver 78 may be a satellite receiver for receiving satellite communications from the satellite content provider over the communication link 48 to the client device 22a, 22b. The user may use the user interface 76 to select one of a plurality of satellite channels that are received by the satellite receiver antenna. In other embodiments, the content receiver 72 may also be a FM or AM radio receiver to receive radio signals 54 from a local content broadcaster in the geographic area for the client device 22a, 22b. This type of broadcast content may be obtained through the content receiver 72 by tuning the content receiver to a specific radio frequency.

In one embodiment, the controller 70 may be configured to obtain stored content (as well as exchange data messages with a host system or other client devices) through the use of the short-range wireless transceiver 80. The short-range wireless transceiver 80 is used for establishing a wireless communication link 52 over a short-range wireless communication system or network. Although shown as part of vehicle entertainment system 24, the short-range wireless transceiver 80 could also be included as part of the Telematics control unit 82 or other vehicle control unit. In any event, the short-range wireless transceiver 80 may provide wireless communication to another client device 22c-22h over a home gateway 60 (such as a data message from the client device 22a, 22b in the vehicle to the client device 22d, 22e in the home) or may provide wireless communication to another client device or content provider through a hot spot provider 42 (such as a data message from the client device 22a, 22b in the vehicle, through the hot spot provider 42, to the client device 22c-22e in the home; or such as obtaining stored content from the internet content provider 36, through the hot spot provider 42, to the client device 22a, 22b).

The memory 74 associated with the client device 22a, 22b may be used for storing content. The memory 74 is controlled by the controller 70 and is responsive to user inputs and to certain data messages that may be received by the controller 70 from other client devices 22c-22h. For instance, assume that a user of the vehicular client device 22a is listening to broadcast content on a specific satellite channel over the content receiver 72. The user may desire to pause the broadcast content while the user talks to another occupant in the vehicle. The user may then select an input on the user interface 76 to pause the content. The system may also be configured to automatically generate a pause command upon the initiation of a user action such as the changing of a channel, selecting a mute button on the entertainment system, or turning off the entertainment system or vehicle.

In response to that input (generated directly or indirectly by the user), the controller 70 would use the memory 74 to begin storing the broadcast content on the specific channel (whether from a satellite provider 38 or a local broadcast provider 44) to enable the user to play back the content at a later time. Additionally, the memory 74 may be used for storing specific programs of the broadcast content that a user desires to playback at a time that is different from the original broadcast time. For example, as explained below, the controller 70 may receive data messages from another client device 22c-22h in a different domain (i.e. home or person). That data message may include an instruction to start the recording of a program of the broadcast content (in whole or in part) on a specific satellite channel or a local broadcast radio channel. Moreover, the memory 74 may be used to download specific content from an Internet content provider 36 through a home gateway 60 or a hot spot provider 42.

In the embodiment where the client device 22a, 22b is incorporated into the vehicle entertainment system 24 of a vehicle, the controller 70 may also be configured to communicate via a vehicle bus interface 78 to a vehicle bus 68, which carries communication information and other operational data throughout the vehicle. This connection may be important to allow the controller 70 to utilize a cellular communication transceiver 84 in the Telematics control unit 82 to transmit and receive data messages. In particular, the Telematics control unit 82 is similarly coupled to the vehicle bus 68, via a vehicle bus interface 86, and hence the vehicle entertainment system 24. The Telematics control unit 82 is responsible for sending and receiving voice or data communications to and from the vehicle over a cellular communication network. As such, it comprises a Telematics controller 88 to organize such communications, and a network access device (NAD) that includes a cellular wireless transceiver 84.

The client device 22a, 22b in the system illustrated above can provide a great deal of communicative flexibility within a vehicle to manage and control content with other client devices 22c-22h owned by a user. As mentioned above, it is expected that not all client devices 22a-22h have the same capabilities to present certain formats of content and not all client devices 22a-22h will have the same network capabilities for accessing content. Accordingly, the present invention advantageously provides mechanisms for managing content between different types of client devices and across different domains.

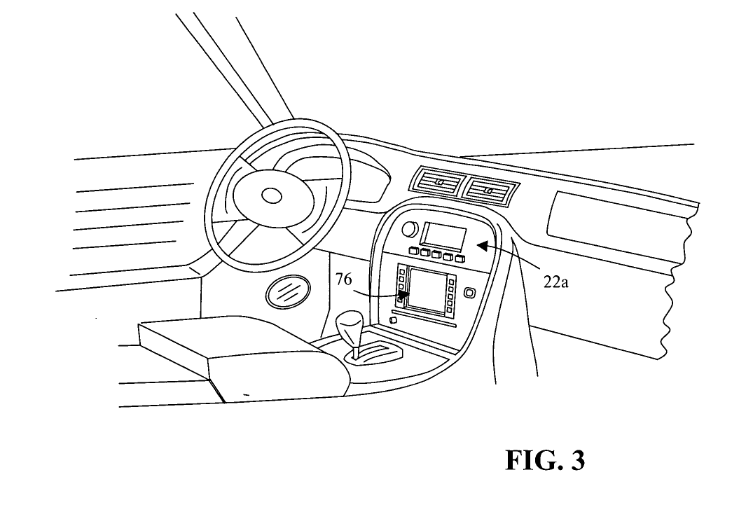

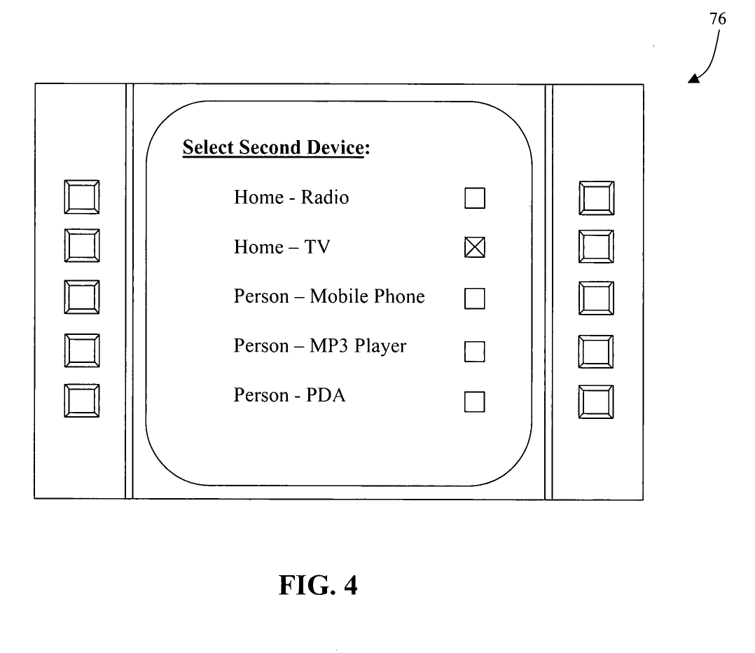

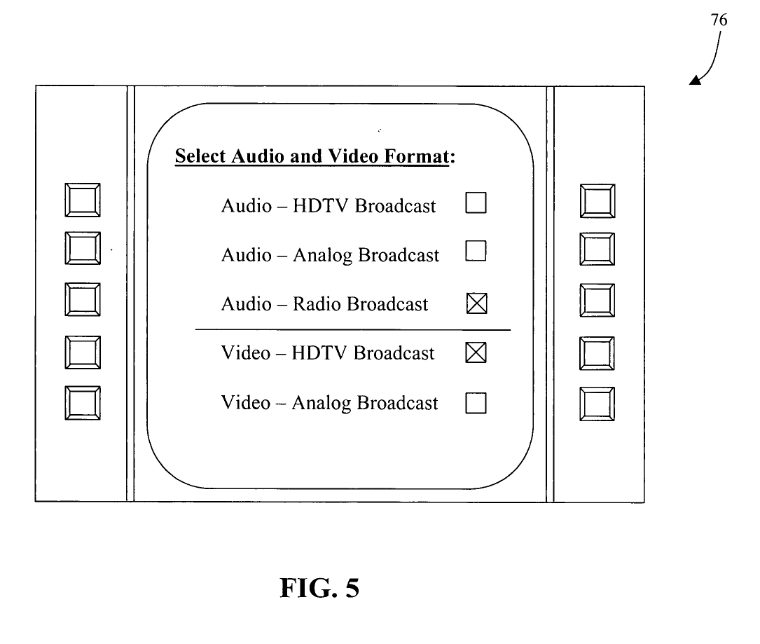

For example, assume for purposes of illustration that a driver of the vehicle, using client device 22a, is listening to a program of audio broadcast content such as a talk show or a sporting event on the content receiver 72. When the driver arrives at their home, the driver may select an input on the user interface 76 to pause the content. Additionally, referring to FIGS. 3 and 4, the user interface 76 may also be configured to receive an input from the user (at any time during a vehicular trip) that allows the user to instruct the system to store content on a second device for playback at a later time. As shown in FIG. 5, the user interface 76 may also be configured to provide a plurality of format options to the user. The user would then be capable of selecting a first format relating to the audio portion of the content and a second format relating to the video portion of the content. As will be explained below, these multiple format options may be used by the media playback control device 30 to combine multiple format streams into a single format for playback on another client device. In any event, as explained in more detail below, in response to a user input, the controller 70 is configured to generate and transmit a data message to the media playback control device 30 or directly to other client devices 22c-22h.

In one embodiment, before sending a data message, the controller 70 would determine whether the client device 22a, 22b in the vehicle is connected to, or capable of sending messages over, a short-range wireless communication system. This may be done by having the controller 70 determine whether the short-range wireless transceiver 80 is connected to a wireless gateway 60 in the home or a hot spot provider 42 mentioned above. If the client device 22a, 22b in the vehicle is not connected to, or not capable of sending data messages over, a short-range wireless communication system, the controller 70 may then make a determination whether the client device 22am 22b in the vehicle is connected to, or capable of sending data message over, a second wireless communication system such as a cellular communication network. The second wireless communication system in FIG. 2 is shown as a cellular wireless transceiver 84 in the Telematics control unit 82. If the client device 22a, 22b is not connected to either the short-range or second wireless communication system, then the controller 70 may store the data message for later transmission.

The data message may be formatted in a number of ways. In one embodiment, the information in the data message will depend on the type of content being played by the driver of the vehicle. For instance, assume that the content receiver 72 is a digital satellite receiver and that the type of content to be played back is live radio-audio content. In this case, the data message may include a plurality of information elements or fields that includes at least an enable playback instruction and a satellite channel identification. To enhance the functionality of the system, the data message may also include other information elements or fields such as an address, a user identification, a sending client device identification, a target client device(s) identification, and a date and a time that the user selected the enable playback command. This later information may be used to help the media playback control device 30 better enable playback of content at a later time.

In another instance, assume that the content receiver 72 is an FM or AM radio tuner and the type of content to be played back is live radio-audio content. In this case, the data message may include a plurality of information elements or fields that includes at least an enable playback instruction and a radio frequency identification. Additionally, to enhance functionality, the data message may also include other information elements or fields such as an address, a user identification, a sending client device identification, a target client device(s) identification, and a date and a time that the user selected the playback content command.

In a further instance, assume that the client device contains, or has access to, stored content and the user was listening to a pre-recorded radio show or program. In this case, the data message may include a plurality of information elements or fields that includes at least an enable playback instruction, a content identification, and a playback location identification. Other information elements or fields that may be included, for enhancing functionality, include an address, a user identification, a sending client device identification, a target client device (s) identification, and a date and a time that the user selected the pause content command.

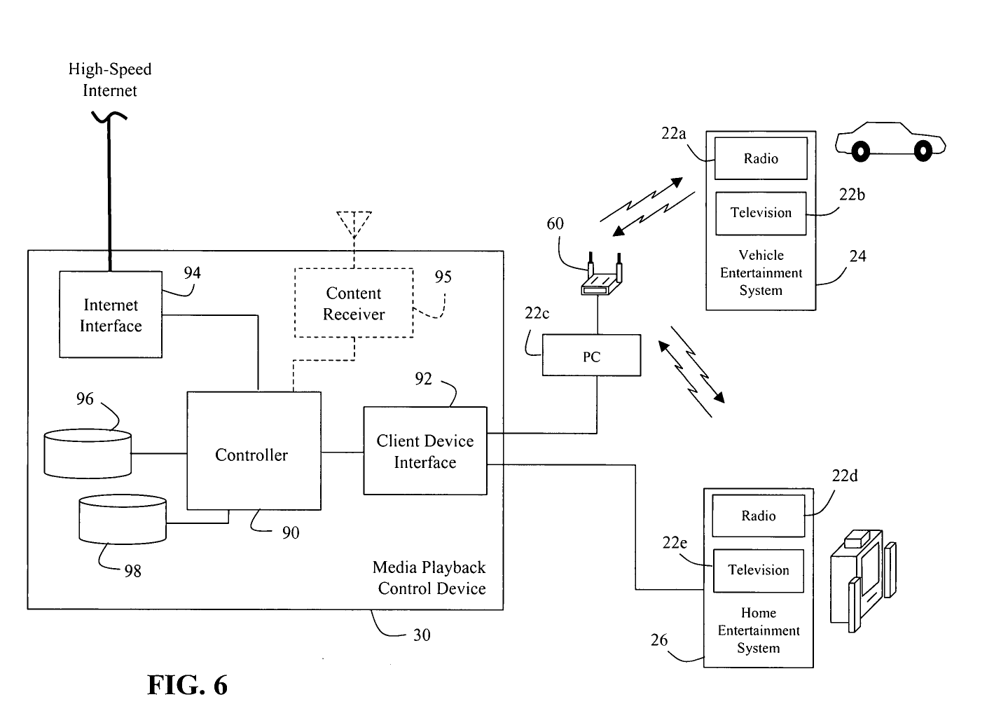

FIG. 6 shows a block diagram of one embodiment of a media playback control device 30 for managing content between a first client device (such a client device 22a, 22b in a vehicle) and a second client device (such as a client device 22d, 22e in the home). In one embodiment, the media playback control device 30 includes a controller 90, a client device interface 92, an Internet interface 94, a database 96, and a memory 98. Optionally, the media playback control device 30 may also have its own content receiver 95. One skilled in the art having the benefit of this disclosure will recognize that aspects of the media playback control device 30, and components thereof, can be combined or swapped with other types of devices and systems. For instance, instead of having the media playback control device 30 located in the home, the controller 90, database 96, and memory 98 may be located and managed remotely by the central service provider 32.

The client device interface 92 may include a wired or a wireless transceiver. In one embodiment, the client device interface 92 is capable of connecting to the first and second client devices 22a, 22b, 22d, 22e over a short-range wireless communication system. The Internet interface 94 may be used for communicating with a central service provider 32. The connection with the central service provider 32 may also be used to facilitate communications with the first and second client device 22a. 22b, 22d, 22e, if the client devices are connected to other wireless gateways (such as a hot spot provider 42) or connected to another wireless communication system (such as a cellular communication system). Moreover, the connection with the central service provider 32 may be used to facilitate access to content providers in addition to, or separate from, the content receiver 95.

In any event, in addition to transferring stored content to client devices, the client device interface 92 and the Internet interface 94 may be used to receive data messages from the first and second client devices 22a, 22b, 22d, 22e, including any data messages that have an instruction to enable the playback of content on a different client device. In one embodiment, as described above, data messages that are received from a client device include a plurality of information elements or fields that include at least an enable playback instruction. The data message may further include information elements or fields that identify client devices, identify content (a specific satellite channel or a radio frequency, or a specific stored song or program), and identify the time and date of the enable playback instruction.

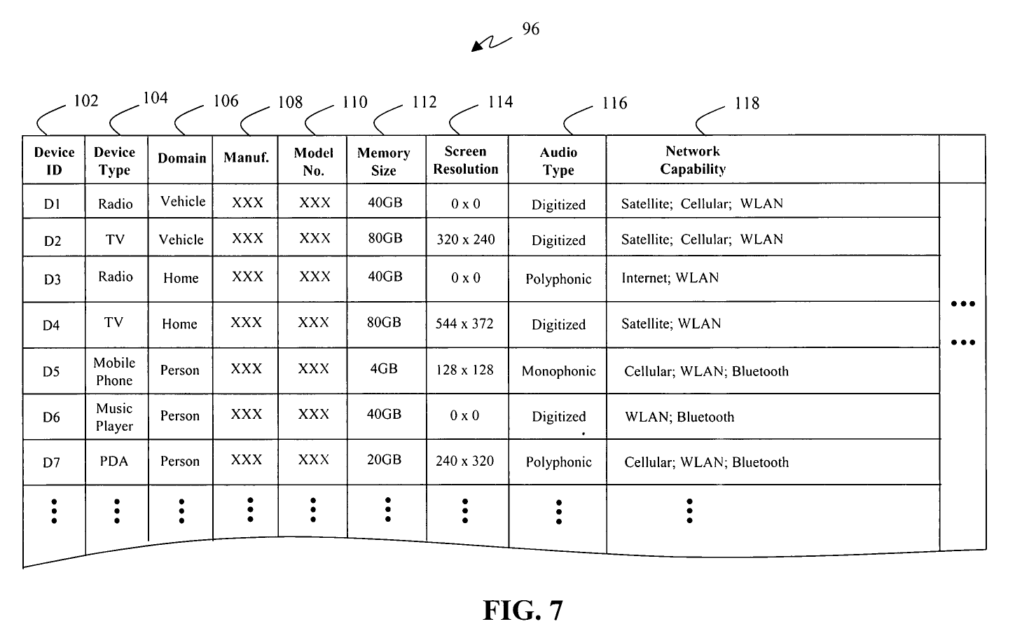

The database 96 is used by the system to store information regarding features and operations of the different client devices 22a-22h. The database 96 may also be used to store user preferences and keep track of user stored content. The database 96 may be configurable by the user to facilitate the storage and playback of content between different client devices 22a-22h in various domains. For instance, the database 96 may identify the different types of client devices 22a-22h, associated with a particular user. Referring to FIG. 7, the database 96 may also include information specific to individual client devices 22a-22h such as: a client device identification (102); a client type (104); a domain identification (106); a manufacturer (108); a model number (110); a size of memory on the client device (112); a screen resolution (114)—0×0 may mean no video capability; an audio type (116); and a network capability of the client device (118).

Referring back to FIG. 6, the controller 90 is connected to the client device interface 92, the Internet interface 94, and the database 96. The controller 90 is capable of receiving data messages from a first client device 22a, 22b and then using the database 96 to identify other client devices 22d, 22e associated with a specific user. As mentioned above, the data message will include an instruction to enable playback and associated information about the playback sought for enablement. In one embodiment, the controller 90 is capable of generating and sending a second set of data messages to other client devices 22d, 22e after receiving the data message from the first client device 22a, 22b. This may be beneficial if the other client devices 22d, 22e have their own content receiver and memory.

In another embodiment, the controller 90 is capable of accessing content from a content provider 36, 38, 40, 42, 44 in response to receiving the data message (containing the enable playback instruction) from the first client device 22a, 22b. This feature may be beneficial if the other client devices 22d, 22e do not have their own content receiver. Additionally, after accessing content from a content provider, the controller 90 may locally store the content in memory 98 or pass the content onto the other client devices 22d, 22e connected to the media playback control device 30.

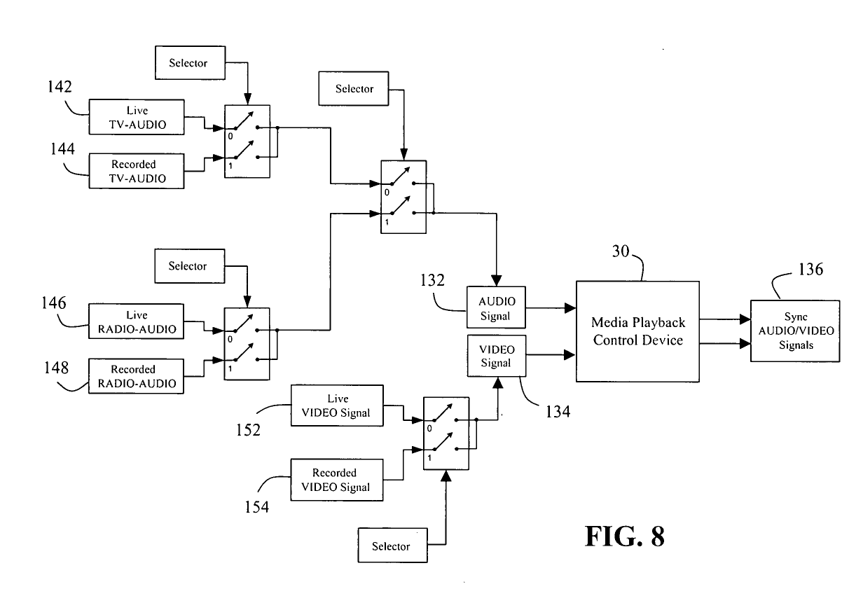

FIG. 8 shows a block diagram of the media playback control device 30 having access to various types of audio and video content. In one embodiment, as an input, the media playback control device 30 is configured to receive an audio signal 132 and a video signal 134. The various types of audio signals 132 and video signals 134 may be received from the Internet interface 94 or the content receiver 95 (shown back in FIG. 6). As an output, the media playback control device 30 will provide a synchronized set of audio and video signals 136. The synchronized set of audio and video signals 136 can then be provided to a client device through the client device interface 92 or back through the Internet interface 94 (shown back in FIG. 6).

In one embodiment, the inputted audio signal 132 may be either live television-audio 142, recorded television-audio 144, live radio-audio 146, recorded radio-audio 148 or other stored forms of audio related content. The media playback control device 30 may select the appropriate inputted audio signal 132 based on the media capabilities of the targeted client device as well as the desired formats requested by the user. Additionally, the media playback control device 30 may be forced to seek recorded audio instead of live audio when live broadcast audio no longer exists. Recorded audio may be obtained from the Internet interface 94 through one of the content providers.

In one embodiment, the inputted video signal 134 may be either live television-video 152, recorded television-video 154, or other stored forms of video related content. The media playback control device 30 may select the appropriate inputted video signal 134 based on the media capabilities of the targeted client device as well as the desired formats requested by the user. Additionally, the media playback control device 30 may be forced to seek recorded video instead of live video when a live broadcast video feed no longer exists. Recorded video may be obtained from the Internet interface 94 through one of the content providers.

The system in FIG. 8 allows for the simultaneous recording of different channels or media formats covering the same event or program. The media may be stored in memory 98 and combined by the controller 90 (shown in FIG. 6) in a variety of different formats and channeled to the user in synchronized audio and video signals. To help synchronize the audio and video signals, it is preferred that each of the inputted audio and video signals be in a form that has timestamps embedded in the signal. This will allow for the audio and video signals to be combined properly according to the embedded timestamps.

For systems that do not include embedded timestamps, synchronization of signals may be accomplished by calculating time offsets from the beginning of a file for a given block of data. For example, for a constant bit-rate audio recording with a constant block size, one may calculate the time offset for a given sample within the file. First, the number of samples per second are calculated. Second, the sample number at a particular point is divided by the number of samples per second to determine the time offset associated with the particular point. The process may then be reversed to find a particular sample that corresponds to a given time offset from the beginning of the file.

Systems utilizing variable bit-rate encoding may also use a similar approach. Take for example a system that utilizes a constant block size where the bit-rate is constant only for that block. The next block is permitted to use a different bit-rate. Thus each block in the file represents a different number of audio samples, and thus a different amount of time. The time offset may then be calculated from the beginning of the file to a given sample by calculating and summing the time offsets for each block up to the block including the given sample, and then adding the time for the samples prior to the given sample in the block containing the given sample. This system can also be done in reverse to find the sample at a given time offset.

Another method of synchronizing playback of multiple different files is to use the time stamps in the file system at the time of the beginning of the recording. It is also possible to store the recording start time. This could be saved in a file or a database on the recording device. A time calibration constant may be determined for each recording and playback system. Given this information, the playback system may synchronize the multiple content streams.

In a further embodiment, it is also contemplated that the system may be configured to allow the user to adjust the time difference between multiple streams when playing back the content. Once adjusted, the adjustment is saved by the system and used for subsequent playback of the given sources. In addition, in many situations, the adjustment may apply to subsequent streams when played back—the user would not have to adjust the time difference again. As an example, if the video and audio recorded by the system is from an internal tuner that is recorded in sync, but the playback mechanism causes the audio to be delayed by 2 seconds more than the video, then once the user has adjusted for this difference any content recorded by the system from these sources and played back by this unit should require the same 2 second time difference.

The ability to combine the various content formats can provide significant benefits to the user. For instance, a user will now have the ability to playback a given event or program (such as a sporting event) by watching the video from a local television broadcast with the audio from a local radio broadcast.

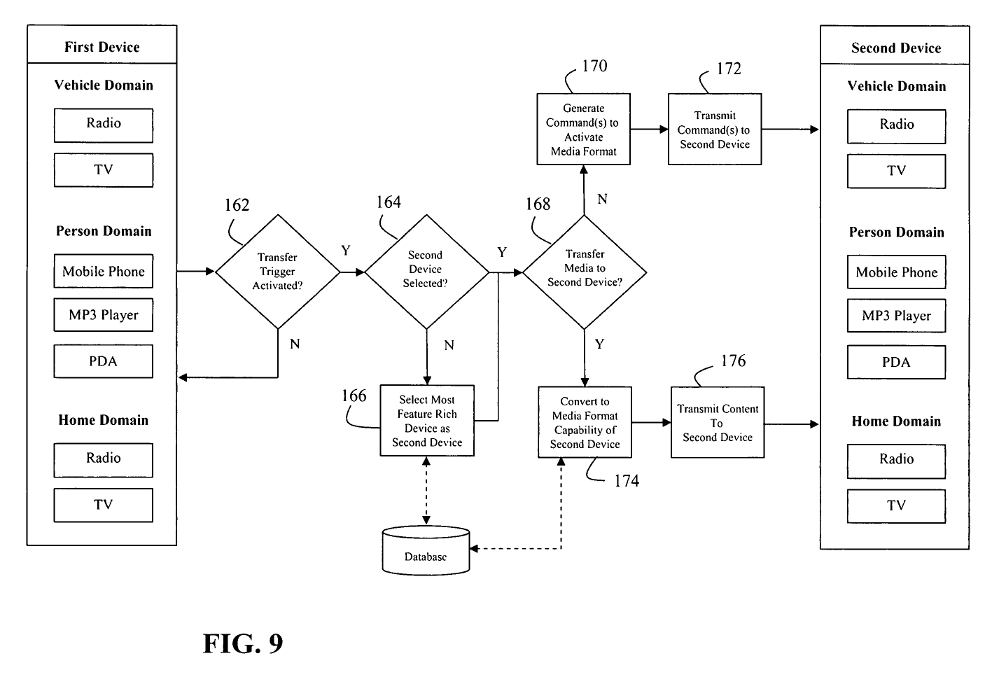

FIG. 9 shows a flow diagram illustrating one embodiment of a method for managing content between a first client device and a second client device. For purposes of illustration, the first client device will be in a first domain and the second client device will be in a second domain. Assume for purposes of illustration that content in a first format is being presented to a user on a first device. In one embodiment, the method includes a decision block 162 that waits to receive a data message from a first client device relating to a command to enable the playback of content in a second client device. As mentioned above, this data message may be sent to the media playback control device 30 as a result of a user input (on the first device) to enable the playback content. This input may be a direct instruction by the user to enable the playback the content (e.g., by pressing a button on the user interface 76). Additionally, the input may be prompted as a result of some action taken by the user (e.g., changing a channel, selecting a mute button on the entertainment system, or turning off the entertainment system or vehicle). Moreover, the content may include either broadcast content or stored content. The process may then proceed to decision block 164.

At decision block 164, the media playback control device 30 will make a determination whether the user has selected a second client device to enable the playback of content. If a second client device has not been selected, the process may continue to process block 166 where the media playback control device 30 may be configured to select a second device. For instance, in one embodiment, the media playback control device 30 may select the most feature rich device as the second client device. It will access the database 96 to determine which of the client devices associated with a particular user has the most feature rich media capabilities. In either event, once a second client device is selected, the process may continue to decision block 168.

At decision block 168, the media playback control device 30 may determine whether any media needs to be transferred to the second device. In one embodiment, the media playback control device 30 will determine a second format for the content to be presented on the second device. Based on this determination, the media playback control device 30 may then look at the capabilities of the second device to determine its next steps. For instance, the media playback control device 30 may access the database 96 to determine whether the second device has independent access to the content in the second format. If the second device has independent access to the content in the second format, then at process blocks 170 and 172, the media playback control device 30 will generate and transmit a data message that includes a command to activate recording of the content in the second format in the second device. In response, the second device will then begin to record the content based on the information contained in the data message. For instance, the second device will continue to store the content on a particular satellite channel or a radio frequency until the second device receives an input from the user to resume playback of the content on the second device. Alternatively, the second device may be configured to store the content for a predetermined period of time after receiving the pause instruction (such as 2 hours) or may be configured to store the content until a particular program on the broadcast content is completed.

Alternatively, at decision block 168, if the second device does not have access to the content in the second format, then the media playback control device 30 may record the content itself (if it has its own content receiver) or access the content from a content service provider. The ability to access content from a content service provider can provide significant benefits to the user. For instance, if the data message originally sent to the media playback control device 30 is late (e.g., if the data message with the enable playback instruction was not sent immediately), the media playback control device 30 may connect to a service provider to download the requested content.

If the needed format capabilities for the second device are not accessible to the media playback control device 30, then as shown in process block 174, the media playback control device 30 may still record the content itself or access the content from a content service provider but will convert the content to the second format (or another format desired by the user). The ability to convert the format of content can provide significant benefits to the user. For instance, the media playback control device 30 can allow the user to combine one or more audio and video formats to provide a synchronized format to the second client device.

In process block 176, the media playback control device 30 will transmit the content in the second format to the second device. In an alternative embodiment, the media playback control device 30 will continue to store the content or access the content until the second device receives an input from the user to resume playback of the content on the second device. Once the user desires to playback the content, the media playback control device 30 will transmit the stored or accessed content to the second device.

What has been described is a communication system in a vehicle that includes the capability of managing and controlling content between different devices in different domains. The system and method allow a user to seamlessly listen (or watch) audio (or video) content when moving from one domain (such as a vehicle) to a different domain (such as home) without missing a portion of that content. The above description of the present invention is intended to be exemplary only and is not intended to limit the scope of any patent issuing from this application. The present invention is intended to be limited only by the scope and spirit of the following claims.

What is claimed is:

1. A method for managing content for presentation on a client device, the method comprising the steps of:
receiving an input from a user to present content on the client device;
providing a plurality of format options to the user, the user capable of selecting a first format and a second format for the content;
accessing the content in a first format;
accessing the content in a second format;
combining the content in the first format with the content in the second format to provide the content in a combined format; and
presenting the combined format on the client device.

2. The method in claim 1, wherein the step of receiving an input from a user to present content is done on a first client device in a first domain and the step of presenting the combined format is done on a second client device in a second domain, the first domain and the second domain selected from a group consisting of the vehicle, home, and person.

3. The method in claim 2, wherein the first client device and the second client device is a portable electronic device or a component from a group selected from a vehicular entertainment system and a home entertainment system.

4. The method in claim 1, wherein the first format is audio related and selected from a group consisting of live television audio, recorded television audio, live radio audio, and recorded radio audio.

5. The method in claim 4, wherein the second format is video related and selected from a group consisting of live video and recorded video.

6. The method in claim 1, wherein the first format is audio related and the step of accessing the content in the first format includes accessing the content from a group consisting of a local radio broadcast provider, a satellite radio provider, and an Internet radio provider.

7. The method in claim 6, wherein the second format is video related and the step of accessing the content in the second format includes accessing the content from a group consisting of a local television broadcast provider, a satellite television provider, and an Internet video provider.

8. A method for selective recording of content for subsequent playback on a client device, the method comprising the steps of:
receiving an input from a user to subsequently playback content on the client device;
providing a plurality of format options to the user, the user capable of selecting a first format and a second format for subsequent playback of the content;
recording the content in a first format;
recording the content in a second format;
synchronizing the content in the first format with the content in the second format to provide the content in a combined format; and
presenting the combined format on the client device.

9. The method in claim 8, wherein the step of receiving an input from a user to subsequently playback content is done on a first client device in a first domain and the step of presenting the combined format is done on a second client device in a second domain, the first domain and the second domain selected from a group consisting of the vehicle, home, and person.

10. The method in claim 9, wherein the first client device and the second client device is a portable electronic device or a component from a group selected from a vehicular entertainment system and a home entertainment system.

11. The method in claim 8, wherein the first format is audio related and selected from a group consisting of live television audio, recorded television audio, live radio audio, and recorded radio audio.

12. The method in claim 11, wherein the second format is video related and selected from a group consisting of live video and recorded video.

13. The method in claim 8, wherein the first format is audio related and the step of accessing the content in the first format includes accessing the content from a group consisting of a local radio broadcast provider, a satellite radio provider, and an Internet radio provider.

14. The method in claim 13, wherein the second format is video related and the step of accessing the content in the second format includes accessing the content from a group consisting of a local television broadcast provider, a satellite television provider, and an Internet video provider.

15. A content playback control device that is capable of managing content for a client device, the content playback control device comprising:
an input for receiving an instruction from a user to subsequently playback content on the client device, the instruction including a selection of a first format of the content and a second format of the content;
a memory for storing the content in a first format and for storing the content in a second format;
a controller for synchronizing the content in the first format with the content in the second format to produce the content in a combined format; and
an output for transmitting the combined format to the client device.

16. The content playback control device in claim 15, wherein the instruction received by the input is sent by a first client device in a first domain and the transmission of the combined format by the output is to a second client device in a second domain, the first domain and the second domain selected from a group consisting of the vehicle, home, and person.

17. The content playback control device in claim 16, wherein the first client device and the second client device is a portable electronic device or a component from a group selected from a vehicular entertainment system and a home entertainment system.

18. The content playback control device in claim 15, wherein the first format is audio related and selected from a group consisting of live television audio, recorded television audio, live radio audio, and recorded radio audio.

19. The content playback control device in claim 18, wherein the second format is video related and selected from a group consisting of live video and recorded video.

20. The content playback control device in claim 15, wherein the first format is audio related and the step of accessing the content in the first format includes accessing the content from a group consisting of a local radio broadcast provider, a satellite radio provider, and an Internet radio provider.

21. The content playback control device in claim 20, wherein the second format is video related and the step of accessing the content in the second format includes accessing the content from a group consisting of a local television broadcast provider, a satellite television provider, and an Internet video provider.
